(19) United States
(12) Patent Application Publication
(10) Pub. No.: US 2004/0171094 A1
(43) Pub. Date: Sep. 2, 2004

(54) Oxygen sensors disposed on a microtiter plate

(76) Inventors: Ingo Klimant, Graz (DE); Christian Krause, Worth a.d.Isar (DE)

Correspondence Address: ROTHWELL, FIGG, ERNST & MANBECK, P.C., 1425 K STREET, N.W., SUITE 800, WASHINGTON, DC, 20005, US

(21) Appl. No.: 10/481,000

(22) PCT Filed: Jun. 17, 2002
(86) PCT No.: PCT/EP02/06662

Related U.S. Application Data
(60) Provisional application No. 60/298,376, filed on Jun. 18, 2001.

(51) Int. Cl. G01N 21/64

(52) U.S. Cl. 435/8; 422/86; 422/83; 435/29

(57) ABSTRACT

The invention relates to a novel sensor wherein the micro titer plates or supports are fitted with wells receiving the specimens to ascertain oxygen content. The wells contain luminescent or fluorescent dyes (for instance platinum, palladium or ruthenium complexes with phenathroline, porphyrin or pyridine ligands) which are imbedded in the particles of a gas-permeable but water-impermeable matrix. The matrix is a polystyrene derivative or a polystyrene copolymer. The particles in turn are dispersed in a second, water-permeable matrix consisting of a hydrophilic polymer such as polyhydroxy methacrylate, polyvinyl alcohol or polyvinyl pyrrolidone.

The present invention relates to a novel sensor system which may be used to measure the oxygen in microtiter plates or in similar systems. By applying a new sensing principle, measurements may be carried out more rapidly and the effects due to the enclosing medium are attenuated.

Producing fine chemicals entails a consumption of raw materials significantly exceeding the required stoichiometric amounts. Bio-catalytic processes are an approach whereby less substrate shall be used and fewer side products are generated. Such resource-saving procedures protect our environment.

In order to fully exploit said above potential and thereby to attain an economically and ecologically competitive process, the process sequence must be accelerated in sustained manner. The heart of these processes is bio-catalysis. While modern genetic procedures (genetic engineering) such as error-prone PCR allow rapid enzyme variations of order of magnitude of 10⁴ to 10⁶ variants, the screening procedures are the bottleneck of development.

The demand for chemical compounds binding specifically onto biological cells has resulted in developing High Throughput Screening (HTS). This procedure makes manifold use of microtiter plates of various formats. The associated microtiter plate readout devices are based on absorption, intensity of fluorescence, fluorescence decay time or/and polarization of fluorescence.

Said procedures tend to be very specific and their application is therefore restricted to selected systems. Accordingly alternatives must be developed that are based on detecting broadly applicable parameters such as oxygen.

It has been known for many years to measure oxygen concentration for its use as a biological parameter. The significance applies not only to screening processes, but also to medical diagnosis, environmental analysis and analytical chemistry. Illustratively monitoring the consumption of dissolved oxygen by microorganisms has long been used as a characteristic of said microorganisms' metabolism. Thus C. E. Cliffcon in 1937 monitored microorganism oxygen consumption over a time interval of several days while using a Warburg flask. That procedure measured the change in oxygen concentration in a slow and cumbersome manner.

A more recent electrochemical device, the so-called Clark electrode, is also used conventionally to measure dissolved oxygen. Unfortunately the Clark electrode when in operation will consume oxygen (thereby reducing the oxygen available to the microorganisms). Consequently the electrode is used only when measuring volumes of 100 ml or more in order to preclude it from affecting the test results.

A “miniature” Clark electrode already has been described, however this implement is complex, consisting of several components, and also must be in contact with the solution to be tested. Whereas it is possible to use an oxygen-permeable membrane for the purpose of averting the interaction between this device's electrode components and the ingredients of the test solution, on the other hand the oxygen still is required to reach its equilibrium when between the test solution and the measuring system, and it shall be consumed the moment it passes through the membrane.

Optical systems have been developed to ascertain oxygen concentrations and to overcome the shortcomings of the Clark electrode systems. The main advantage of said optical procedures is that the instrumentation required for quantitative determination need not itself come into physical contact with the test solution. Optical procedures allowing both colorimetric and fluorometric oxygen analysis which can be performed quickly and which are reproducible are known and their costs of analyzing are fairly low. Illustratively various luminescence methods have been described regarding oxygen determination which rest on the ability of oxygen to quench the emissions of fluorescence or phosphorescence of a number of compounds. However such procedures have not been matched to-date to the special screening requirements.

The German patent document 3,346,810 C2 describes sensing system to determine the presence of oxygen in an environment comprising a luminescent material of which the luminescent intensity and duration of luminescence may be quenched by oxygen, said luminescent material being imbedded into a support material relatively permeable to oxygen and relatively impermeable to interfering quenching agents. This system also requires a comparison display which is hermetically sealed against the oxygen to be analyzed.

The European patent document 0,509,791 B1 discloses a method and system to detect the presence in a liquid of breathing aerobic bacteria. The effect of oxygen is to lower the intensity of fluorescence. The fluorescence sensor is imbedded in a matrix which is impermeable to water and to non-gaseous, dissolved materials while on the other hand being highly permeable to oxygen. The presence of a water-impermeable matrix is required to reduce the effects of the specimen ingredients on the sensor. This design however entails considerable drawbacks. On one hand the water-impermeable matrix constitutes an oxygen reservoir that may falsify the test result. Another drawback is the comparative low sensitivity of the method. On one hand the sensitivity of detecting the presence in a liquid of breathing aerobic bacteria is adequate for the application discussed in the said European patent 0,509,71 B1—an oxygen-saturated solution being initially present and then this oxygen concentration dropping sharply to stabilize at a lower value—great differences in oxygen concentration may be detected. On the other hand mammalian cells consume much less oxygen and the much smaller changes in oxygen concentrated taking place in their presence demand a method offering significantly higher sensitivity. Moreover the fluorescence sensor's water-impermeable matrix must be in equilibrium with the liquid in which it is immersed before it can emit a signal change due a change in oxygen content. At the boundary surface between the water-impermeable matrix and the liquid enclosing it there is however an additional equilibrium which begins only after a time delay. Thus, there is a long response time. The above application described in the European patent document 0,509,791 B1, namely the detection of breathing aerobic bacteria, monitors comparatively slow processes, its response time being adequate for the purpose. For instance enzyme reactions on the other hand do entail a rapid change in the oxygen amount in the liquid around the sensor. Thus the oxygen concentration may drop from 100% air saturation to 0% air saturation in less than one minute. Such rapid processes cannot be detected by a sensor described in the European patent document 0,059,791 B1.

Accordingly the objective of the present invention is improved system detecting oxygen, in particular in the form of microtiter plate or a culture dish with an integrated sensor system. Another objective of the present invention is to allow this system to measure the oxygen concentration without the employed sensor acting as an interfering reservoir of oxygen. Again an objective of the present invention is to determine the oxygen content after only a brief time delay (low response time), nominally within 5 minutes or less. Another objective of the present invention is to detect rapid changes in oxygen concentration.

The above cited and related objectives are implemented by the method and system of the invention. Said methods and system employ a fluorescence detection system wherein the fluorescent sensor compound shows a quantifiable degree of extinction when exposed to oxygen. Special advantages are attained when using a hydrophilic matrix. As a result most of the liquid part of a specimen may penetrate and cross the sensor matrix. Accordingly the sensor matrix does not act as a reservoir of oxygen. Furthermore the sensor is in tighter contact with the specimen and assures measurements of low response times.

One objective of the present invention is system which detects oxygen and which is defined in claim 1. Preferred embodiments of this system are defined in dependent claims 2 through 13.

Said system may be used to detect oxygen in a specimen, in particular a biological specimen, for instance a culture of microorganisms or higher cells or in enzyme reactions.

A preferred embodiment of the optical oxygen sensor in the system of the invention consists of the following components: a luminous dye of which the phosphorescence is quenched by the oxygen in the specimen. This dye is enclosed within small polymer particles (diameters between a few nm and a few μ). The particle material is characterized by being hydrophobic. This feature assures that the imbedded water-impermeable dye shall not be washed out by proteins. Contrary to the case of other apparatus (for instance the European patent document 0,509,791 B1) wherein the oxygen-sensitive dye is situated with a hydrophobic matrix, the individual oxygen-sensitive nano particle or micro-particle already is a fully screened sensor. As a result cross-sensitivities due to water or other substances dissolved in water are substantially excluded. There is no need therefore to enclose the particles in a hydrophobic matrix to screen the luminescence sensor. Accordingly the particles may be integrated into an arbitrary and therefore also water-permeable layer.

Integration into such water-absorbing, swelling matrix offers the following advantages over the system fitted with a hydrophobic matrix:

1. The sensors' response time is critically shortened. Response times in the seconds range are feasible. This may be attributed on one hand to the sensor layer not being a reservoir of oxygen and on the other hand to the same reactions being possible in the swollen matrix as in the supernatant specimen.

2. Because of its hydrophilic properties, the sensor is well suited for cell cultures. As regards apparatus of the European patent document 0,509,971 B1 on the other hand, its hydrophobia is ill suited for cell cultivation. Among the illustrative reasons for the latter system's performance is that cells growing in adhering manner prefer hydrophilic surfaces for their growth. Moreover additional coatings of solutions for instance of polylysine, fibronectin or collagen are used for difficult cells. Preparation of such coatings is favored when on hydrophilic surfaces.

3. Linear, ethanol-soluble hydrogels may be used for the integration matrix. In this manner the manufacturing procedure of the microtiter plates will be substantially simplified. The matrix need not be crosslinked and cleavage products need not be removed from the sensors by means of cumbersome washing procedures. In this way manufacture is considerably shortened with attending lowering of production costs.

In a still further embodiment mode of the invention, its system is fitted with an additional solution coating, for instance polylysine, fibronectin or/and collagen, for instance to improve cell growth.

In yet another embodiment mode of the present invention, its system may comprise two or more spectrally different luminescence dyes. One dye may be in the form of an indicator and another as the reference dye. In particular two spectrally different dyes are used, of which the first is oxygen-sensitive and the second, relative to the first, is substantially oxygen-insensitive. The sensitivities to oxygen should be substantial enough to be distinguished by measurement, and in operation, the sensitivity of the indicator dye shall illustratively be at least 10 times, preferably at least 100 times, and still preferably at least 1,000 times the sensitivity of the reference dye.

Preferably, the second dye is selected from the group of rhodamines, xanthenoids, styrene dyes and merocyanines. Preferably the first dye is selected from the group of Pt(II)-porphyrins, Pd-(II)-porphyrins and Ru(II)-complexes with poly-N-heterocycle, for instance polypyridyl ligands. Two luminescences are read for signal detection. This signal is the quotient of the two luminescence intensities or decay times. An internally referenced signal is obtained.

The reference dye need not be incorporated into the first matrix, it also may be present externally. In some applications, such measurement may be advantageously carried out using luminophores because allowing higher accuracy because temporal fluctuations of light intensity in the light source being employed, as well as temporal fluctuations in the sensitivity of the readout unit being used may be referenced, and in large part wavelength-independent superpositions of the sensor signal and of specimen intrinsic luminescence may be largely referenced.

Furthermore the two dyes may be mixed during preparation at a constant ratio, whereby the resultant signal shall be independent of the applied quantity of dye mixture, so that wider tolerances are permissible when coating the absolute quantity of sensor being used. The wider tolerance allowed in preparation allows using lesser quantities of coating substance.

In this embodiment of the system of the invention it is feasible as well to only measure the intensity of the luminescence or the indicator dye's luminescence decay time.

Illustrative Preparation for Microtiter Plates with Hydrophilic Oxygen Optodes

A) Prescribed Preparation of Oxygen-Sensitive Particles

1 ml of 10% (w/w) polystyrene suspension (Aldrich, 45, 948-8) is mixed with 3 ml water and 1 ml methanol and stirred for 1 h. 200 μltr of a solution of 0.1 mg Pt(II)meso-tetra(pentafluorophenyl)porphine (Porphin Products, Pt T975) in chloroform are added to the above mixture and the whole is stirred for 24 h. The particles are centrifuged off and are washed several times with ethanol and resuspended in 1 ml ethanol.

B) Prescribed Preparation of O₂ Cocktails

(1) 500 mg polyhydroxyethyl methacrylate (PolyHema, Polysciences, 09698) are dissolved in 10 ml ethanol and 100 μltr water. 1 ml of the suspension described in A) is added to this solution and the whole is stirred for 12 h.

(2) 500 mg polyhydroxyethyl methacrylate (PolyHema, Polysciences, 06989) and 0.1 mg rhodamine-B-octadecylester perchlorate (Fluka, 83685) are dissolved in 10 ml ethanol and 100 μltr water. 1 ml of the suspension described in A) is added to this solution and the whole is stirred for 12 h.

In addition to the hydrophobically encapsulated porphine dye, the cocktail described in B2) also contains a rhodamine reference dye.

C) Prescribed Coating of Microtiter Plates (MTP) with Oxygen Sensors 96′ well format:

1.5 μltr of the cocktail described in B1) or B2) is dispersed in each MPT well. The plate may be gamma-sterilized after the solvent has been evaporated.

The invention is further elucidated in the appended Figures.

FIG. 1 shows a fluorescence spectrum of a sensor of the invention free of oxygen and saturated with air. FIG. 1 shows that the fluorescence intensity substantially drops due to air saturation (excitation: 540 nm).

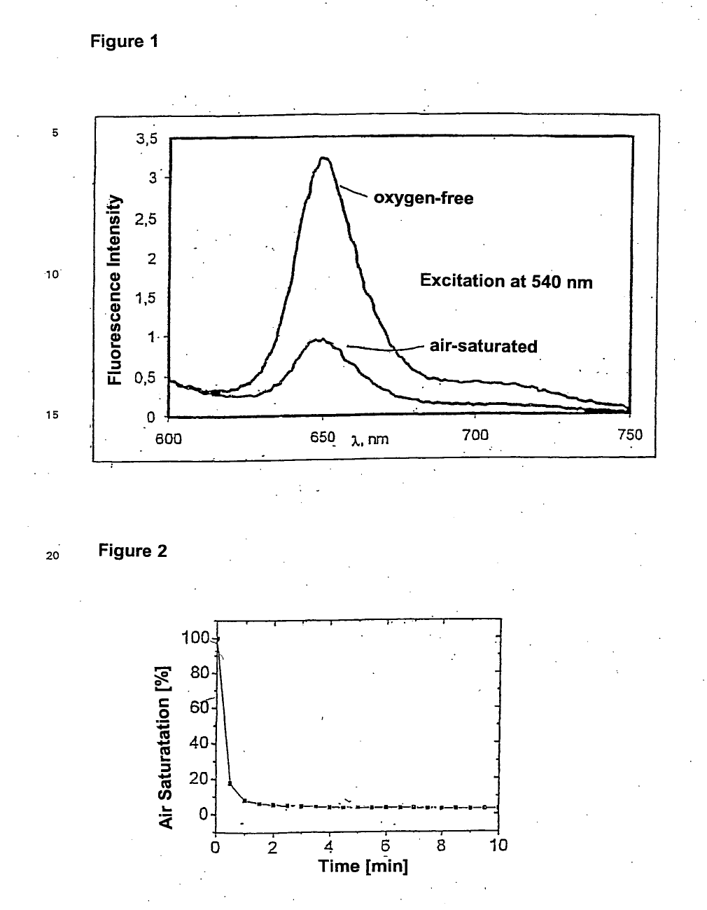

FIG. 2 shows the response time of a sensor of the invention as a function of air saturation (%). The sensor of the invention exhibits a comparatively short response time even at low contents of air.

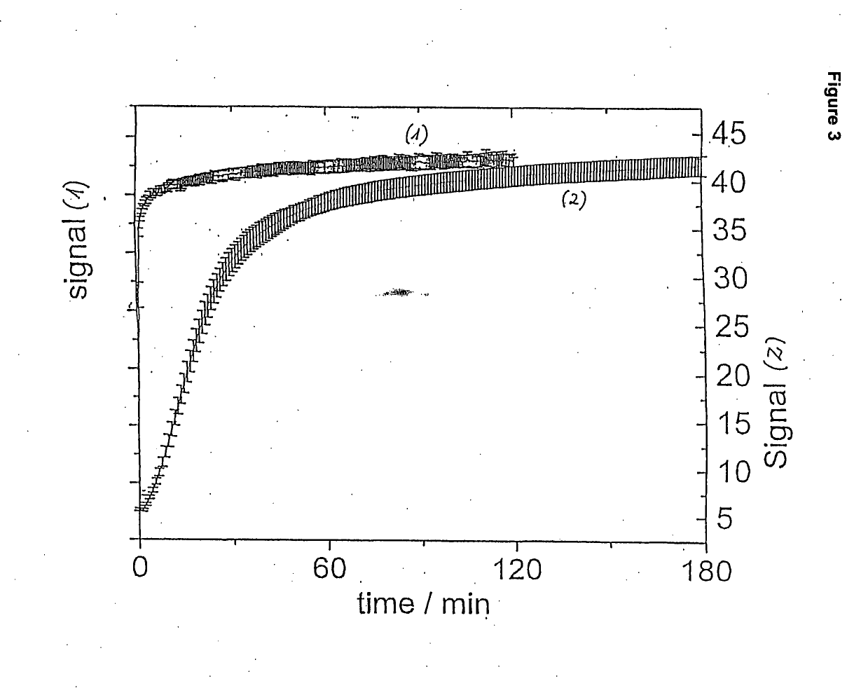

FIG. 3 compares the oxygen signal of a sensor of the invention (1) and a sensor disclosed in the European patent document 0,509,791 B1 (2). The sensor of the invention offers a substantially shorter response time.

1. Oxygen-detecting system comprising:
a support fitted with several wells receiving specimens and oxygen sensors, said sensors comprising
(a) particles which contain
(i) a first luminescent indicator dye quenchable by oxygen, and
(ii) a gas-permeable, substantially water-impermeable first matrix, and
(b) a substantially water-permeable second matrix, the particles (a) being dispersed
in the second matrix (b), and
(c) a reference dye which is spectrally different from the first dye and substantially oxygen-insensitive, the indicator dye's sensitivity being higher by a factor≧10 than the sensitivity of the reference dye.

2. Apparatus as claimed in claim 1, characterized in that it is designed as a microtiter plate.

3. Apparatus as claimed in claim 1, characterized in that it is designed as a culture dish to cultivate microorganisms or higher cells, for instance mammalian cells.

4. Apparatus as claimed in one of claims 1 through 3, characterized in that the luminescent dye is a phosphorescence dye.

5. Apparatus as claimed in one of claims 1 through 4, characterized in that the luminescent dye is selected from Pt-(II)-porphyrins, Pd-(II)-porphyrins and Ru-(II)-complexes with poly-N-heterocycle, for instance polypyridyl ligands.

6. Apparatus as claimed in one of claims 1 through 5, characterized in that the first matrix contains polystyrene, polystyrene derivatives or/and copolymers with polystyrene or polystyrene derivatives.

7. Apparatus as claimed in one of claims 1 through 6, characterized in that the second, water-permeable matrix is capable of absorbing at least 10% by weight water.

8. Apparatus as claimed in one of claims 1 through 7, characterized in that the second, water-permeable matrix contains polyhydroxyethyl methacrylate, crosslinked polyacrylamide, crosslinked polyvinyl alcohol, hydrophilic polyurethane hydrogels, crosslinked polyvinylpyrrolidone or mixtures thereof.

9. Apparatus as claimed in one of claims 1 through 8, characterized in that the oxygen sensors are layers preferably 1 to 100 μ (microns) thick.

10. Apparatus as claimed in one of claims 1 through 9, characterized in that the particle diameter is between 10 nm and 50 μ.

11. Apparatus as claimed in one of claims 1 through 10, characterized in that the reference dye is selected from the group of rhodamines, xanthenoids, styrene dyes and merocyanines.

12. Application of the system defined in one of claims 1 through 11 to detect or/and quantify oxygen in a specimen.

13. Application as claimed in claim 12, to detect or/and quantify oxygen in a biological specimen.

14. Application as claimed in either of claims 12 and 13, to detect or/and quantify oxygen in a culture of microorganisms or higher cells.

15. Application as claimed in either of claims 12 and 13, to detect or/and quantify oxygen in enzyme reactions.
